(19) United States
(12) Patent Application Publication
(10) Pub. No.: US 2026/0040130 A1
(43) Pub. Date: Feb. 5, 2026

(54) METHODS, ARCHITECTURES, APPARATUSES AND SYSTEMS FOR DATA MULTI-CONNECTIVITY IN ENERGY SAVING NETWORKS

(71) Applicant: InterDigital Patent Holdings, Inc., Wilmington, DE (US)

(72) Inventors: Faris Alfarhan, Montreal (CA); Oumer Teyeb, Montreal (CA); Umer Salim, Vallauris (FR); Jaya Rao, Montreal (CA); Paul Marinier, Brossard (CA)

(21) Appl. No.: 18/792,011

(22) Filed: Aug. 1, 2024

(51) Int. Cl. H04W 28/02; H04W 76/28

(52) U.S. Cl. CPC H04W 28/0221; H04W 76/28

(57) ABSTRACT

Methods, apparatuses, systems, devices, and computer program products related to data multi-connectivity in energy saving networks. One method may include receiving information indicating (1) a first cell group and a second cell group and (2) one or more data flows, where the first cell group and/or the second cell group can apply network energy saving (NES) techniques, and where the data flows are associated with radio resources of the first cell group or the second cell group. Based at least on a NES state being activated on the first cell group, the method may include moving a data flow associated with the radio resources of the first cell group to the second cell group that is not in the NES state. The method may include applying a protocol chain configuration associated with the second cell group for uplink data transmission, and transmitting the uplink data on the second cell group.

### FIELD

Example embodiments described in the present disclosure are generally directed to the fields of communications, software and encoding, including, for example, to methods, architectures, apparatuses, systems related to data multi-connectivity in energy saving networks.

### BACKGROUND

Network energy savings relates to enhancements that enable the network to minimize its power consumption from transmission and/or reception. Such minimization of power consumption can be beneficial for reducing operational costs and for environmental sustainability.

### SUMMARY

Some embodiments may be directed to a wireless transmit/receive unit (WTRU) that includes circuitry, such as any of a processor, memory, transmitter and receiver. The circuitry may be configured to receive configuration information indicating (1) a first cell group and a second cell group and (2) one or more data flows, where at least one of the first cell group and the second cell group are capable of applying network energy saving techniques, and where the data flows are associated with radio resources of one of the first cell group and the second cell group. Based at least on a network energy saving state being activated on the first cell group, the circuitry may be configured to route, reroute, switch and/or move a data flow associated with the radio resources of the first cell group to the second cell group that is not in the network energy saving state. The circuitry may be configured to apply a protocol chain configuration associated with the second cell group for uplink data transmission, and to transmit the uplink data and/or control information on the second cell group.

Some embodiments may be directed to a method, which may be implemented by a wireless transmit/receive unit (WTRU). The method may include receiving configuration information indicating (1) a first cell group and a second cell group and (2) one or more data flows, where at least one of the first cell group and the second cell group are capable of applying network energy saving techniques, and where the data flows are associated with radio resources of one of the first cell group and the second cell group. Based at least on a network energy saving state being activated on the first cell group, the method may include routing, rerouting, switching and/or moving a data flow associated with the radio resources of the first cell group to the second cell group that is not in the network energy saving state. The method may include applying a protocol chain configuration associated with the second cell group for uplink data transmission, and transmitting the uplink data and/or control information on the second cell group.

Some embodiments may be directed to a wireless transmit/receive unit (WTRU) that includes circuitry, such as any of a processor, memory, transmitter and receiver. The circuitry may be configured to receive configuration information indicating (1) at least two cell groups and (2) one or more data flows for which data can be routed on one or more the at least two cell groups, where one or more of the at least two cell groups are capable of applying network energy savings. The circuitry may be configured to, based at least on a network energy saving state being activated on one of the at least two cell groups, route, reroute, switch and/or move a data flow associated with the one of the at least two cell groups to another one of the at least two cell groups, where the another one of the at least two cell groups is not in the network energy saving state.

Some embodiments may be directed to a method, which may be implemented by a wireless transmit/receive unit (WTRU). The method may include receiving configuration information indicating (1) at least two cell groups and (2) one or more data flows for which data can be routed on one or more the at least two cell groups, where one or more of the at least two cell groups are capable of applying network energy savings. Based at least on a network energy saving state being activated on one of the at least two cell groups, the method may include routing, rerouting, switching and/or moving a data flow associated with the one of the at least two cell groups to another one of the at least two cell groups, where the another one of the at least two cell groups is not in the network energy saving state.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2A illustrates an example of a MCG split bearer, a SCG bearer and a SCG split bearer, according to some embodiments;

FIG. 2B illustrates an example protocol stack of a MN and SN, respectively, according to some embodiments;

FIG. 3 illustrates an example of the switching, moving and/or routing of a data flow from one cell group to another cell group, according to some embodiments; and

FIG. 4 illustrates an example of the SDAP layer, according to some embodiments;

FIG. 5 illustrates an example SDAP diagram, according to some embodiments;

FIG. 6 illustrates an SDAP data PDU format without SDAP header, according to some embodiments;

FIG. 7 illustrates a DL SDAP data PDU format with SDAP header, according to some embodiments;

FIG. 8 illustrates an UL SDAP Data PDU format with SDAP header, according to some embodiments;

FIG. 9 illustrates an example of an end-marker control PDU, according to some embodiments;

FIG. 10 illustrates an example flow diagram of a method, according to some embodiments; and

FIG. 11 illustrates an example flow diagram of a method, according to some embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

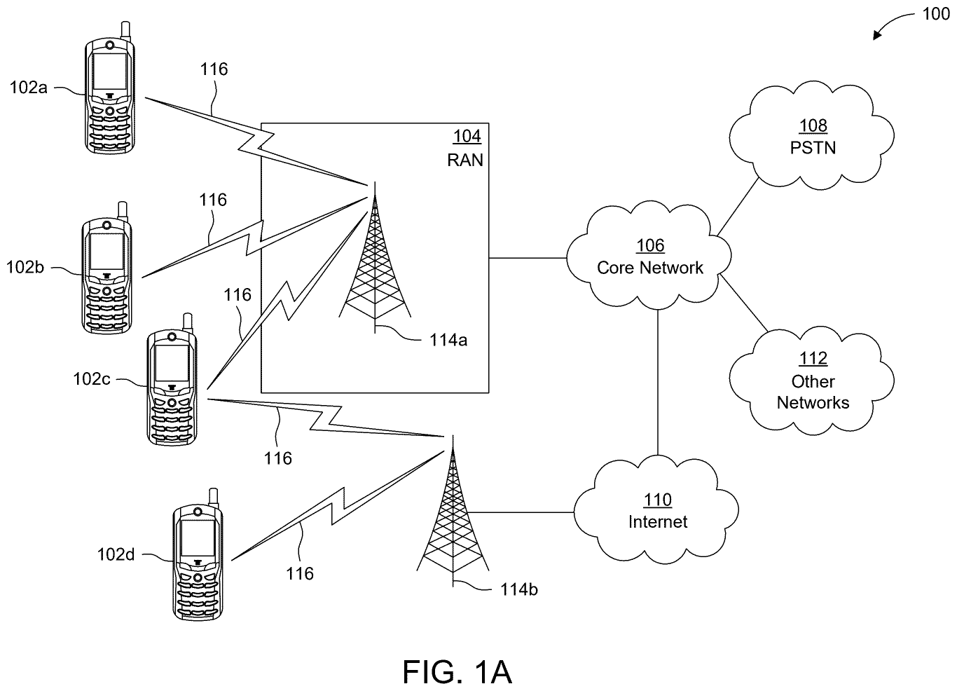

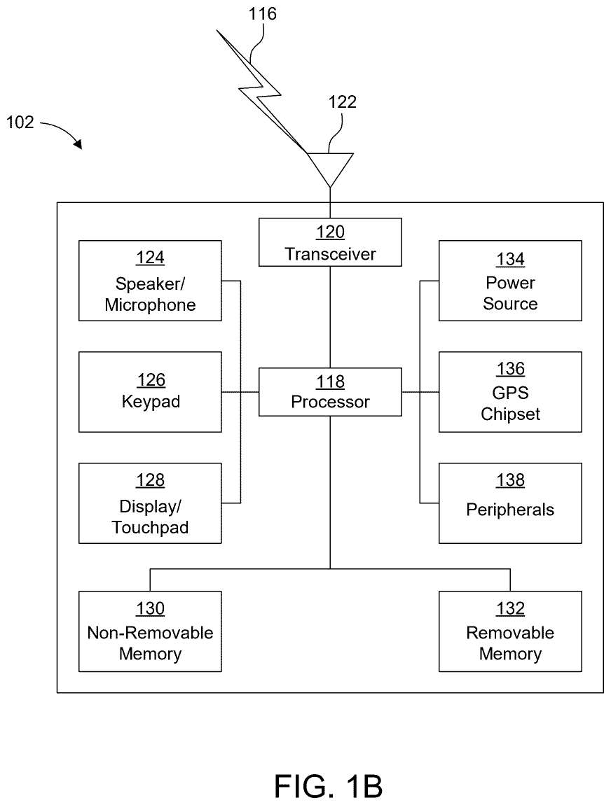

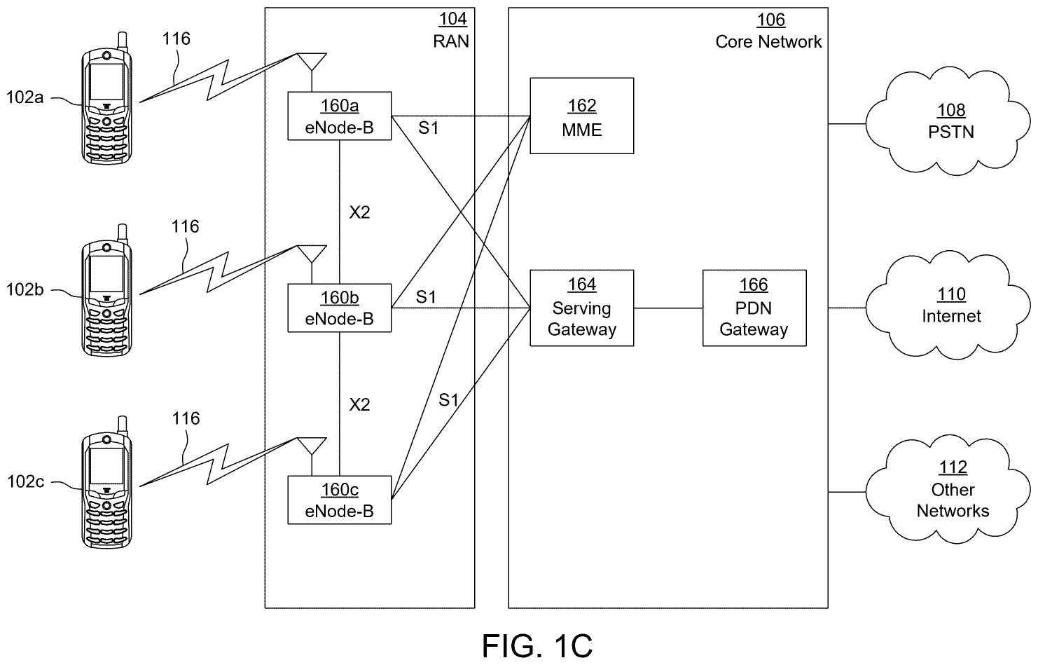

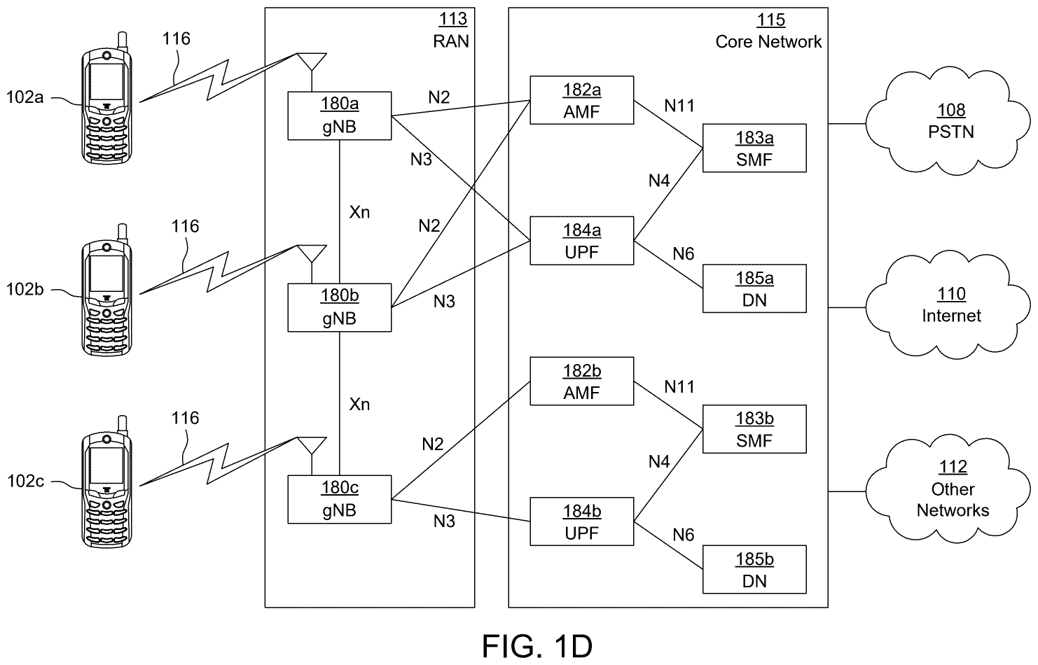

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d, or any other WTRU mentioned or described herein, may be interchangeably referred to as a UE or vice versa.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHZ, 40 MHZ, 80 MHZ, and/or 160 MHz wide channels. The 40 MHz, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHZ to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Embodiments disclosed herein are representative and do not limit the applicability of the apparatus, procedures, functions and/or methods to any particular wireless technology, any particular communication technology and/or other technologies. The term network in this disclosure may generally refer to one or more base stations or gNBs or other network entity which in turn may be associated with one or more Transmission/Reception Points (TRPs), or to any other node in the radio access network.

It is noted that, throughout example embodiments described herein, the terms “base station”, “serving base station”, “RAN,” “RAN node,” “Access Network,” “NG-RAN,” “gNodeB,” and/or “gNB” may be used interchangeably to designate any network element such as, e.g., a network element acting as a serving base station. It should be understood that embodiments described herein are not limited to gNBs and are applicable to any other types of base stations.

It is further noted that, as used herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) may be used herein to represent ‘and/or’, where for example, ‘A/B’ may imply ‘A and/or B’.

Network energy savings for 3GPP Rel-18 is being studied to produce enhancements enabling the network to minimize its power consumption from transmission and reception. Such minimization can be beneficial for reducing operational costs and environmental sustainability.

Compared to earlier systems, the design of NR of Rel-15 is very efficient from the perspective of minimizing transmissions from the network when there is no data. For example, always-on cell-specific reference signal (CRS) is not used in NR. However, there is still potential for energy consumption reduction.

NR cell discontinuous transmission/discontinuous reception (DTX/DRX) mechanisms are designed to manage the downlink transmission and uplink reception activities of a network node (e.g., gNB) and WTRUs or UEs. Traditionally, C-DRX is configured per WTRU or UE, and DRX cycles or offsets are aligned via radio resource control (RRC). During the UE DRX off period, the WTRU or UE does not monitor the physical downlink control channel (PDCCH) but can initiate UL transmission using predefined resources. Cell DTX/DRX aims to inform WTRUs or UEs about cell inactivity, potentially enhancing UE DRX configurations for better alignment of DRX cycles or start offsets, leading to prolonged cell inactivity. In Cell DTX/DRX periods, the cell may limit its transmissions to reduce activity, omitting certain periodic signals or channels. During non-active periods, the WTRU or UE does not transmit scheduling request (SR) or configured grant physical uplink shared channel (CG-PUSCH) and the WTRU or UE does not monitor select channel state information (CSI)-reference signal (RS) and semi-persistent scheduling (SPS)-physical downlink shared channel (PDSCH) transmissions.

The configuration of Cell DTX/DRX involves specifying periodicity, start slots/offsets, and on-duration, which can be managed separately for DL and UL or jointly. These configurations are usually applied to WTRUs or UEs in the RRC_CONNECTED state and can be activated or deactivated dynamically via group common L1 downlink control information (DCI) signalling and RRC signalling. WTRUs or UEs can handle multiple cell DRX/DTX configurations for different serving cells simultaneously, with the ability to switch between configurations based on network signaling. Active periods refer to when the configured DTX/DRX patterns are operational and the cell DTRX on duration timer is running, while inactive periods are when they are not, allowing UEs to manage their monitoring and transmission activities efficiently during these times.

The network may also dynamically turn off some cells all together to save energy. Prior to such an event, the network may send a conditional handover (CHO) indication to allow remaining WTRUs or UEs to handover to other cells.

For a multi-connectivity bearer, the WTRU or UE maintains a layer 2 (L2) protocol stack per serving cell group. In NR and LTE, such splitting of the protocol stack is in the Packet Data Convergence Protocol (PDCP) layer. In Dual connectivity, master cell group (MCG) bearer data only goes on the master node (MN) leg. Secondary cell group (SCG) bearer data only goes on the secondary node (SN) leg.

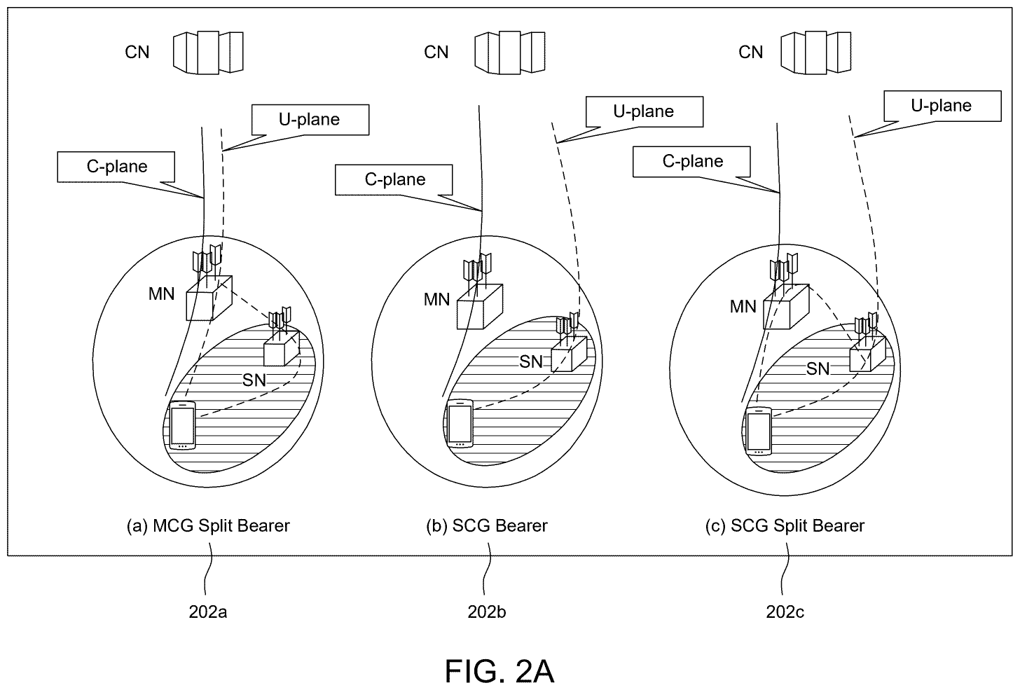

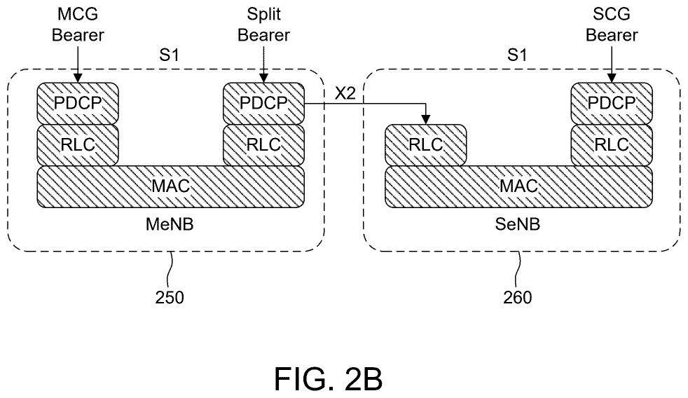

FIG. 2A illustrates an example of a MCG split bearer 202a, a SCG bearer 202b and a SCG split bearer 202c. FIG. 2B illustrates an example protocol stack of a MN 250 and SN 260, respectively.

For split bearers, the PDCP entity is associated with two radio link control (RLC) entities, each associated with the MCG or the SCG leg. One of the RLC entities is configured as the primary RLC and a buffer level threshold, which may be called ul-DataSplitThreshold, may be configured for the bearer. If the buffered data for that bearer is below this threshold, the PDCP will push data to (e.g., only to) the primary RLC entity. If the buffered data for the bearer is above this threshold, the PDCP may push the data to either the primary or secondary RLC entity. A split bearer may be used for duplication purposes, and if duplication is activated, duplicate the PDCP data PDUs are submitted to both RLC entities (i.e. regardless of the buffer levels).

SRB1 and SRB2, which are terminated at the MN, may be configured as split bearers, but for (e.g., only for) duplication purposes.

The existing data plane currently does not work practically well for networks using network energy saving methods (e.g. cell DTX, dynamic power off/on, which can be signalled dynamically), such as in dual and multi-connectivity scenarios where there is more than one serving cell group. In particular, at least the following issues may exist: data routing in DC with network energy saving (NES), split bearer operation with NES, and/or duplication operation over radio paths.

Data routing of data is semi-statically configured as MCG or SCG and does not consider dynamically changing NES states of the different network nodes or gNBs in DC. Therefore, an issue or problem relates to how to enable the SN (e.g., SN gNB) to sleep without completely de-configuring SCG bearers.

Currently, when split bearer is configured, if the amount of UL data is less than a threshold (e.g., ul-DataSplitThreshold), the WTRU or UE selects (e.g., always selects) the primary leg (e.g., MN) for the data transmission per current specification, even if this leg is in a NES state (e.g., cell DRX).

Further, if the amount of UL data is larger than a threshold (e.g., ul-DataSplitThreshold), the UE implementation can select either the MN or the SN leg, without regard to which leg is in a NES state. NES may be activated on one leg or both legs (e.g., MN and/or SN gNBs). Further, network “availability” may not be simultaneous or aligned between both legs.

Currently, a PDCP duplicated bearer submits PDUs to lower layers simultaneously regardless of their NES states (e.g., cell DRX or other). NES may be activated on one leg or both duplication legs (e.g., MN and/or SN gNBs). Further, network “availability” may not be simultaneous or aligned between both legs. This can intentionally create protocol data units (PDUs) that will be discarded due to the lag and/or period between the two legs.

In view of the above, a problem exists with respect to how to enable change of routing dynamically at L2 (e.g., what changes in the protocol stack should be made to support this, such as header indications, security/ciphering, etc.). Another issue may relate to path selection and packet handling (e.g., where to route packets or data flows) when a SCG goes to sleep (e.g., when multiple alternatives are possible including not changing path). Some alternatives may include: (a) semi-static, configuration-based and/or pre-configured (e.g., configuration associated to NES state), (b) per-UE and/or dynamic based on, e.g., WTRU or UE measurements (e.g., WTRU/UE selects based on, e.g., RSRP), and/or (c) per-packet rule and/or dynamically based on packet characteristics or LCH (e.g., delay requirements (with respect to cell turning on again), duplicate or not).

According to some embodiments described herein and in more detail below, if one cell group is in an active NES state, the WTRU may reroute a data flow to another cell group (e.g., RLC entity), such as another cell group on which NES state is not active (without having to reconfigure the bearer to another node by RRC signaling).

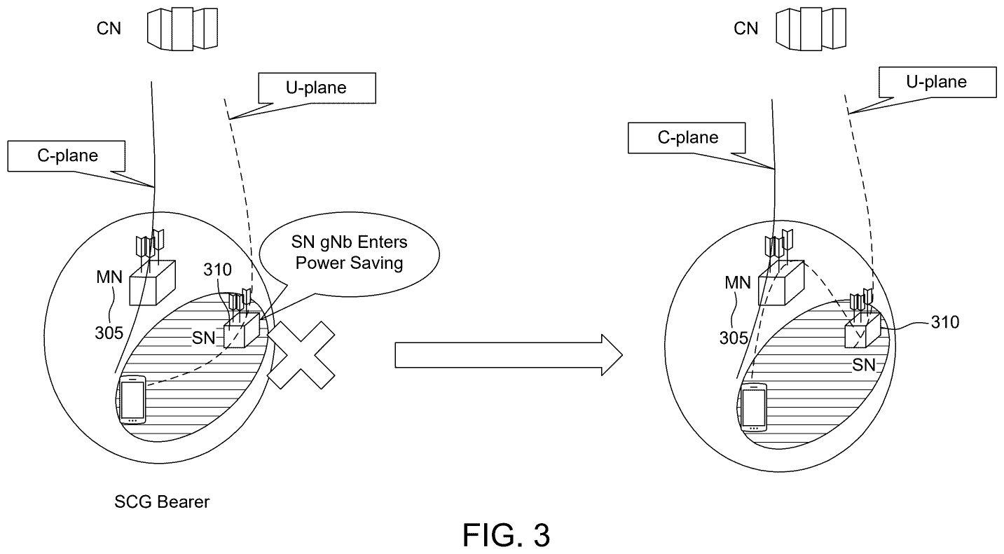

FIG. 3 illustrates an example of the switching, moving and/or routing of a data flow (e.g., a packet flow, data packets, QFI, etc.) from one cell group (e.g., a gNB, MN gNB or SN gNB) to another cell group (e.g., a gNB, MN gNB or SN gNB), based on a NES or power saving state of the cell group(s). In particular, FIG. 3 shows an example of the routing, switching or moving of a data flow to a MN gNB 305, when the SN gNB 310 enters a NES or power saving state, according to some embodiments. It is noted that, in some embodiments, the data flow may be routed, switched and/or moved to the SN gNB 310 when the MN gNB 305 enters a NES or power saving state. Procedures for the switching or moving of the data flow from one cell group (e.g., a gNB, MN gNB or SN gNB) to another cell group (e.g., a gNB, MN gNB or SN gNB) are discussed in further detail below.

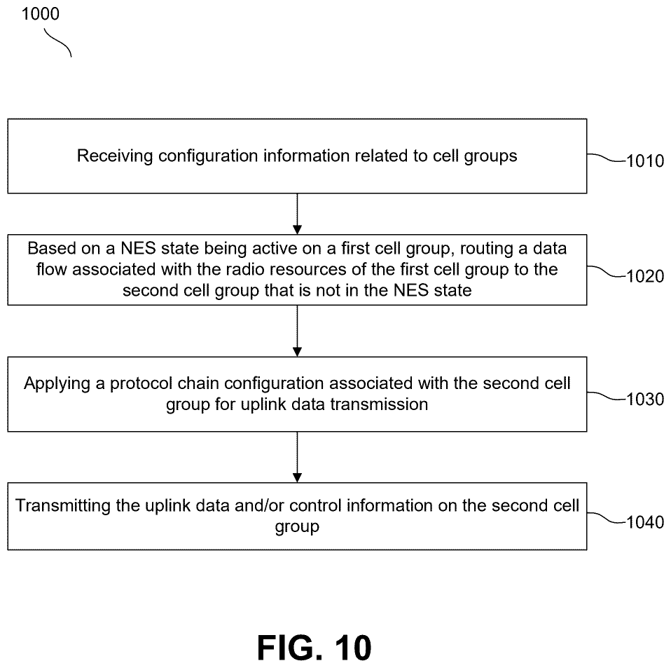

In some embodiments, as will be described in more detail below (e.g., in connection with FIG. 10), a WTRU may be configured (e.g., may receive configuration information) with two or more cell groups (e.g. for multi-connectivity), where at least one cell group (e.g., gNB) can apply NES (e.g., an NES technique such as cell DTX, turn off, or be in an NES state). A cell group (e.g., each cell group) may be configured with one or more protocol chain configurations (e.g., PDCP, RLC, and/or security configuration) to apply for a given cell group.

According to some embodiments, the WTRU may be configured with (e.g., may receive configuration information) one or more data flows (e.g., QoS flows). A data flow (e.g., each data flow) may be configured with a mapping or association to radio resources, e.g., on a particular cell group (e.g., a QoS flow to DRB mapping).

In some embodiments, the WTRU may route, reroute, move and/or switch the data flow (e.g., a packet flow, QFI, data packets, etc.) to another cell group that is not in an NES state. For example, upon activation of an NES state on a given cell group (e.g., gNB, MN, SN), the WTRU may route the data flow to another cell group that is not in an NES state. According to certain embodiments, other conditions may be considered. These other conditions may include, for example, data volume, latency, congestion, etc. For example, according to certain embodiments, the WTRU may consider data volume, latency, and/or congestion when deciding whether to route a data flow to another cell group that is not in an NES state. In some embodiments, the WTRU may route the data flow to another cell group that is not in an NES state, for instance, if the time that the currently mapped cell group will remain in an NES state is larger than a configured threshold.

According to some embodiments, upon switching the data flow to another cell group, the WTRU may apply the protocol chain configuration associated with the new cell group for new (e.g., all new) uplink data transmitted. Once the switching is done, buffered transmission service data units (SDUs) may be rekeyed using the applicable security configuration. In some embodiments, the WTRU may provide an indication in a protocol header or in control PDU or control element (CE), e.g., a PDCP control element or MAC CE, to indicate to the receiver which protocol chain config is used. The indication may provide a distinction relative to other data transmitted normally over that path (e.g., by configuration). The indication may indicate that the data would normally have been routed to the other cell group. The WTRU may include an indication of the data volume that would have normally been routed to the other node (e.g., a special type of a buffer status report or BSR).

Examples embodiments may provide several benefits. For example, some example embodiments allow for dynamic and/or non-static routing of data to a given cell group, especially when one cell group activates an NES state. Additionally, some example embodiments allow for activation of a NES technique on a dynamic basis, without requiring RRC reconfiguration to remap a data flow (e.g., QoS flow) to a data radio bearer (DRB) or change the DRB type (e.g., from SCG bearer to an MCG bearer), etc.

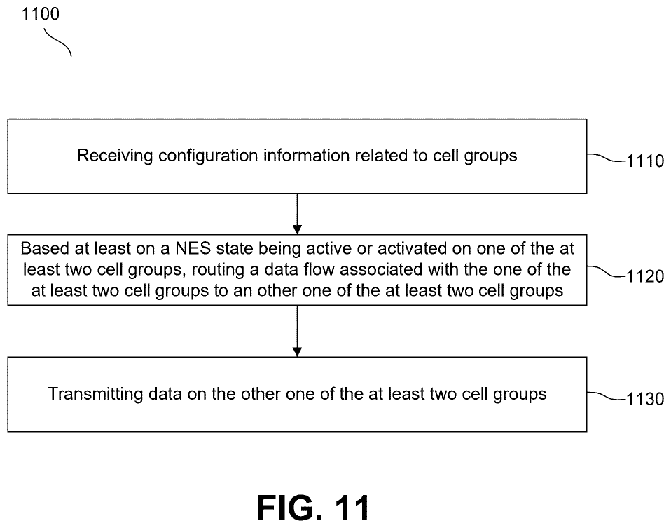

According to some embodiments, for a split bearer across two cell groups employing NES, a WTRU can dynamically select a cell group based on the NES state and the next uplink transmission availability occasion (e.g., as discussed in more detail below, such as in connection with FIG. 11).

In some embodiments, as will be described in more detail below (e.g., in connection with FIG. 11), a WTRU may be configured with (e.g., may receive configuration information indicating) two or more cell groups (e.g., for multi-connectivity), where at least one cell group (e.g., gNB or base station associated with the cell group) can apply NES (e.g., are capable of or are configured to apply an NES technique, such as cell DTX, cell DRX, turn off, or otherwise be in an NES state).

In some embodiments, a WTRU may be configured with (e.g., may receive configuration information indicating) one or more data flows (e.g., QoS flows) on which data can be routed on one or more cell group(s) (e.g., a split bearer).

According to some embodiments, the WTRU may switch, route or move, or may determine to switch, route or move, the data flow to a certain cell group (e.g., a cell group selected by the WTRU). For example, in some embodiments, upon activation of an NES state on a given cell group (e.g., gNB or base station), the WTRU may switch/route/move, or determine to switch/route/move, the data flow to the cell group (e.g., RLC entity) that is not in a NES state (e.g., the WTRU may select a cell group that is not in a NES state to move the data flow to). Additionally or alternatively, the WTRU may switch/route/move, or determine to switch/route/move, the data flow to the cell group (e.g., RLC entity) on which the next uplink transmission availability occasion is sooner (e.g., earlier in time) than the current cell group. Additionally or alternatively, in certain embodiments, the WTRU may switch/route/move, or the WTRU may decide or determine to route/move or not route/move the data flow, to a cell group possibly based on any one or more of: data volume associated with the data flow (e.g., based on the data volume being above or below a threshold), the characteristics of the data flow or data associated with the data flow, and/or the data type associated with the data flow (e.g., user data, control data, sensory data, positioning, or AI/ML/system data). For example, if the amount of data is greater than a threshold (e.g. a configured threshold), the WTRU may wait for a SN active period (e.g., may wait for the SN to exit NES state) or may transmit a wake up request on the SN; otherwise, the WTRU may route the data flow to the MN path. As another example, the WTRU may determine to route/move or not route/move the data flow to a cell group based on the data being from or associated to a given logical channel (LCH), data flow and/or DRB, and/or or is of a certain type.

In some example embodiments, a cell DTX pattern may be activated on SN. According to some embodiments, during the cell DTX active period of the SN, the WTRU can select the SN leg. During the non-active period of the SN, the WTRU can select the MN leg to transmit the data. If there are multiple candidates for cell groups that are not in a NES state and the configured bearer's cell group is in a NES state, the WTRU may have a prioritization order for selection of an alternative group, where the priority order is configured or predefined or selected based on the amount of data.

In view of the above, some example embodiments may allow for dynamic and/or non-static routing of data to one or more cell group(s), such as when one of the cell groups activates an NES state. Additionally, some example embodiments may allow for activation of a NES technique on a dynamic basis, without requiring RRC reconfiguration to remap a data flow (e.g., QoS flow) to a DRB or change the DRB type (e.g., from SCG bearer to an MCG bearer), etc.

As used herein, channel conditions may refer to any conditions relating to the state of the radio/channel, which may be determined, by the UE, from a UE measurement (e.g., L1/SINR/RSRP, CQI/MCS, channel occupancy, RSSI, power headroom, exposure headroom), L3/mobility-based measurements (e.g. RSRP, RSRQ, s-measure), an radio link monitoring (RLM) state, and/or channel availability in unlicensed spectrum (e.g., whether the channel is occupied based on determination of an LBT procedure or whether the channel is deemed to have experienced a consistent LBT failure).

As used herein, a PRACH resource may refer to a PRACH resource (e.g., in frequency), a PRACH occasion (RO) (e.g., in time), a preamble format (e.g., in terms of total preamble duration, sequence length, guard time duration and/or in terms of length of cyclic prefix) and/or a certain preamble sequence used for the transmission of a preamble in a random-access procedure.

As used herein, uplink control information (UCI) may include or may refer to CSI, HARQ feedback for one or more HARQ processes, Scheduling request (SR), Link recovery request (LRR), CG-UCI and/or other control information bits that may be transmitted on the PUCCH or PUSCH.

A property of scheduling information (e.g., an uplink grant or a downlink assignment) may include at least one of the following: a frequency allocation; an aspect of time allocation, such as time instance or/and a time duration; a priority; a modulation and coding scheme; a transport block size; a number of spatial layers; a number of transport blocks to be carried; a TCI state or SRI; a number of repetitions; whether the grant is a configured grant type 1 (i.e., UE immediately using the configured UL resources after receiving the configuration information), type 2 (i.e., UE waiting until an explicit MAC CE indication before using the configured UL resources) or a dynamic grant.

An indication, such as by DCI, may include at least one of the following: an explicit indication by a DCI field or by RNTI used to mask CRC of the PDCCH; an implicit indication by a property, such as DCI format, DCI size, Coreset or search space, aggregation level, identity of first control channel resource (e.g., index of first CCE) for a DCI, where the mapping between the property and the value may be signaled by RRC or MAC; an explicit indication by a DL MAC CE.

Herein, a NES state or an availability state may refer to a cell state in which the network node, cell or TRP has activated at least one NES technique. An NES technique may include any of: reduced SIBI transmission (periodic or existence), reduced SSB transmission (periodic or existence), cell DTX, cell DRX, spatial domain adaptation (where a subset of antenna ports and/or elements are turned off), power domain adaptation (where a subset of channels are transmitted with reduced power or muted), the cell or TRP has turned off, and/or the like.

A WTRU may determine whether it can transmit or receive on certain resources depending on a network availability state. A network availabitliy state may imply or include for example the network's (e.g., the gNB's) power savings status, a network energy savings (NES) state, a cell DTX mode, a cell DRX mode, and/or a gNB activity level. An availability state can be uplink or downlink specific, and may change from symbol to symbol, slot to slot, frame to frame, or on a longer duration granularity. The availability state may be determined by the WTRU or indicated by the network (NW). An availability state can be, for example, “On”, “DL and UL active”, “UL only active”, “off”, “reduced Tx power”, “dormant”, “sleep (de)-activated”, “micro sleep”, “light sleep”, “deep sleep”, the active period of a sleep pattern, and/or the deactive period of a sleep pattern.

In a sleep pattern, the active period may correspond to the time when the NW may actively transmit DL signals/channels and/or the time when the NW may blind decode for UL signals/channels. Such states can be abstracted by NW configuration parameters and/or values, and dynamic indication may point to the active availability state (e.g., by DCI or MAC CE signaling). The “Off” availability state or the non-active period of sleep pattern may imply that the gNB's baseband hardware is completely turned off. The “sleep” availability state may imply that the gNB wakes up periodically to transmit certain signals (e.g. presence signals, synchronization, or reference signals) or receive certain UL signals. In some availability states, some DL or UL resources are not available during certain periods of time, and this enables the network to turn off baseband processing and other activities. For example, the WTRU may be configured by RRC with periodic Active and Inactive periods per availability. Some measurement resources (e.g. SSBs or CSI-RS) may only be made available in certain availability states, including: RLM, BFD, RRM measurements, CSI-RS feedback configuration, and/or a different power offset for CSI feedback.

Under certain conditions, the WTRU may further transmit a request to the network (wake-up request) to modify the availability state to a state for which resources that would satisfy WTRU requirements are available. The WTRU can determine an availability state from reception of availability state indication from, e.g., by L1/L2 signalling (e.g., a group common DCI or indication), or implicitly determine it form the reception of periodic DL signalling or lack thereof.

The WTRU may determine if a resource is available for transmission/reception and/or measurements for the determined network availability state if it is applicable in the active availability state. In addition, the WTRU may also adapt its active C-DRX cycle, active spatial elements (e.g., antenna or logical ports), active TRPs, paging occasions as a function of the signalled or determined availability state. The WTRU may be configured with one or more sets of NES transmission and/or reception parameters per availability state, e.g., by broadcast or dedicated configuration signalling. The WTRU may apply the NES parameter set according to the determined or signaled availability state. The WTRU may apply one or more applicable configurations depending on the determined NES state. A set of NES parameter may include: a number of antenna ports, a C-DRX configuration, a measurement configuration (e.g. for RRM, RLM, and/or BFD), CSI feedback, a CSI-RS configuration, an SSB configuration, CHO or mobility candidates, and/or a set of active TRPs.

An availability state may be applicable to at least one transmission, reception, or measurement resource. An availability state may be applicable to at least one time period such as a time slot or time symbol. An availability state may be applicable to a serving cell, a cell group, a frequency band, a bandwidth part, a TRP, a set of spatial elements, or a range of frequencies within a bandwidth part. For example, when an NES state changes in a cell, the WTRU may receive an availability state change indication indicating that this change is just for that cell, for all cells at the same frequency, and/or same RAT.

The WTRU may consider the active availability state associated with a cell, carrier, TRP, or frequency band to be “Off”, “Deep sleep”, or “Micro sleep” after reception of a DL signaling that changes the cell's or TRP's availability state. For example, the WTRU may receive a turn off command on broadcast signaling, RRC signaling, DCI (e.g. a group common DCI), or a DL MAC CE (e.g. indication part of PDSCH). The WTRU may determine an availability state from reception of availability state indication from, e.g., L1/L2 signalling (e.g. a group common DCI or indication) or broadcast signalling associated with an availability state.

For example, an availability state change indication could also be part of S1 update or SIB signalling (e.g., in a separate SIB that is not read by legacy UEs). There can be a common time for the WTRUs (e.g., all WTRUs) in the cell to determine availability state status.

For example, the WTRU may determine a change of NES state change from the reception of a group common command L1 signaling (e.g., a group common DCI, a multi-stage DCI, a specific DCI format, or a DCI scrambled by a configured or specified NES-specific RNTI). L1 signaling may indicate one of the configured NES parameters sets to apply or may determine a delta configuration from the current set of parameters upon determining an NES state change. The WTRU may transmit feedback/acknowledgment to the network (e.g., gNB), possibly multiplexed with UL data (e.g., part of an UL TB as a MAC CE or a subheader indication), following the reception of NES state change indication.

For example, the WTRU may determine a change of NES state change from the reception of broadcast signaling associated with NES state indication or change, including signaling in SIB(s) or part of a broadcast or multicast PDSCH. The WTRU may be indicated the NES state explicitly in the SIB. The WTRU may be configured with one or more SIBs exclusively associated with configuration of NES parameters. The WTRU may be configured to receive such broadcast or multicast indication periodically; the WTRU may determine an indication is mis-detected if not received on expected periodic occasions, if a number of misdetections is counted, and/or if a timer has elapsed since the last reception of the NES state indication. The WTRU may start inter-cell, inter-frequency, and/or inter-RAT measurements, start a mobility procedure, and/or start evaluating configured CHO candidates following the determination of a misdetection of the NES state indication.

In some examples, the WTRU may implicitly assume a certain availability state associated with a cell, carrier, TRP, or frequency band (e.g., “Off, “deep sleep”, “micro sleep” or dormant”) from at least one of the following: reception of a command or signal indicating a change in availability state (e.g., a group common DCI in connected mode or RRC signaling or a presence signal. The WTRU may determine an availability state implicitly form the reception of periodic DL signaling. The WTRU may be configured or specified to associate an availability state with one or more DL signal type (e.g., SSB, partial SSB, and/or one or more periodicity)); reception of a paging message, paging DCI, paging PDSCH, or a paging related signal or PEI (e.g., possibly on a subset of POs (e.g., those aligned with NES drx cycle or a configured subset of PDCCH resources). The WTRU may assume a certain availability state after reception of an indication part of the DCI or PDCCH scheduling paging (e.g., as a function of the P-RNTI, NES-RNTI or based on receiving an explicit indication, e.g., on a reserved bit). The WTRU may assume a certain availability state after the reception of a paging message with a certain P-RNTI, a separately configured NES P-RNTI, or the NES group RNTI. The WTRU may assume a certain availability state after the reception of a paging message with a certain P-RNTI.

The WTRU may be configured with one more PEI subgroup for NES, where a subgroup may be associated with one or more availability states. The WTRU may assume a certain availability state after reception of a PEI with an NES subgroup, possibly if that subgroup is configured and/or associated with the availability state. The indication of the availability state or the availability state switch may be indicated in the paging payload, e.g., as a flag part of the paging message or the short message. Such paging indication may further indicate an alternative cell to monitor paging on while the cell from which the signaling was received is off, sleep, or in NES state. Such paging indication may further indicate or signal applicable reconfiguration parameters (e.g., for initial access, applicable PRACH resources, applicable SSB/RS occasions, applicable S1 cycle, and/or the applicable cell(s) and associated availability states); reception of a paging message, paging DCI, paging PDSCH, or a paging related signal (e.g., PEI); the gNB DTX status (whether the gNB is in active time or an associated activity timer is running); lack of detection of a presence indication (e.g., WTRU may determine an availability state associated with the cell, e.g., “off” or “deep sleep”), e.g., if presence indication was not detected on one or more presence indication occasions.

The WTRU may assume or change the cell's availability state after a number of consecutive misdetections or after timer expires following no detection of a presence signal. The WTRU may determine an availability state is active or de-active after expiry of a timer associated with the availability state. Such timer can be configured and/or maintained in connected mode only, or also in other states (e.g., idle and inactive states). The WTRU may determine an availability state implicitly form the lack of reception of periodic DL signaling. For example, the WTRU may be configured with a signal quality threshold (e.g., an RSRP threshold) and if the WTRU does not detect a signal associated with an availability state (e.g., a presence signal or an SSB) with a signal strength above the threshold, the WTRU may assume that this availability state is not active and may assume a different availability state. This criterion can be also coupled with lack of detection of an identifying sequence of the presence signal (e.g., detection of the PSS sequence for example); based on time in the day, e.g., WTRU may be configured to automatically assume a certain availability state (e.g., off, sleep, or dormant) for a configured subset of cells (e.g., capacity boosting cells) depending the time in the day. For example, the WTRU may determine that a capacity boosting cell has an availability state as “On” in certain hours of the day, “Deep sleep” in other configured hours, and “Off” in a third set of configured hours of the day or night); based on the availability state of an associated cell (e.g. another carrier of the same MAC entity, another carrier in the same cell group, another carrier in the same gNB, another sector in the same gNB, or a configured associated cell or capacity boosting cell); based on detection of a PSS only signal or a simplified/stripped down SSB signal; based on detection of an RS signal (e.g., CSI-RS, PRS, TRS) or the lack thereof; the UE's RRC state (idle, inactive, or connected mode); whether paging has been received, possibly within a configured time window; whether system information (e.g. periodic S1 or a subset of SIBs) have been received, possibly within a configured time window; measured channel condition(s) being below or above a threshold (e.g., the WTRU may assume a change of NES state based on a change of measured channel conditions or making a channel measurement below or above a threshold. For example, the WTRU may use degradation in measurements of SSBs or CSI-RS, possibly in combination with other signaling to determine the NES state. For example, a configured window following the DCI reception can be used to measure SSBs and/or CSI-RS for degradation, and if a delta of SSB-RSRP drop is measured the WTRU may determine that the NES state has changed and assume associated actions for such NES state (e.g., trigger for CHO candidate selection or for group scheduling for a mobility command).

The WTRU may be configured to monitor an indication that may characterize the level of network activity (e.g., an availability state). The network activity may be associated with a base station, gNB, a cell and/or a TRP. The UE may assume the same availability state for all cells part of the same base station, TRP or gNB, e.g., cells of the same MAC entity. The network activity indication (e.g., the presence indication) may include a channel (e.g., a PDCCH) and/or a signal (e.g., a sequence). The activity indication or the NES state change indication/command may indicate the level of activity the WTRU may expect from the associated base station, TRP, gNB and/or cell, e.g., reduced activity. The activity indication may contain activity information of other base stations, gNBs and/or cells. The activity indication may be a PDCCH containing group common signaling. For example, the NW may transmit a group common DCI to a group of WTRUs (e.g., WTRUs in the serving cell) indicating a change of an activity state or activity level in UL and/or DL. The CRC of the PDCCH may be scrambled with a dedicated “activity indication RNTI or an NES-RNTI.” A WTRU may be configured with at least one search space associated with the monitoring occasions of the activity indication PDCCH. The indication may include a go-to-sleep signal, e.g., a predefined sequence. When a WTRU detects this sequence, the WTRU may expect a reduced activity level over a specific time duration. The WTRU may activate C-DRX for the period of time indicated. Alternatively, two sequences may be used to indicate regular activity and reduced activity.

For example, the signaling within the PDCCH or the activity indication may contain at least one of the following: expected activity level of the associated base stations/gNBs/cells over a specific time interval (e.g., an availability state). The activity levels may be predetermined and/or configured and may, for example, include regular and reduced activity. The signaling may indicate the activity level. For example, bit “1” may indicate regular activity and bit “0” may indicate reduced activity; for each activity level (e.g., availability state) transmission and reception attributes may be defined (for example, during reduced activity, WTRU may not be expected to monitor certain PDCCH search spaces (including all SSs), and/or receive a certain type of PDSCH (including all PDSCH), and/or transmit PUCCH/PUSCH, and/or perform certain measurements. The WTRU may start or stop monitoring PDCCH and/or TCI states associated with determined NES state, including PDCCH resources or TCI states associated with (de-)activated TRPs or spatial elements; a set of configurations may be associated with an activity level and may be used/applied when that activity level is indicated (e.g., an NES parameter set). For example, SS configurations, CSI reporting configurations, indices of transmitted SSBs, etc. Each set of configurations may have an attribute associated with an activity level. For example, a tag that can be set to “reduced activity”; the time interval over which an activity level is assumed may be signaled in the PDCCH or part of the activity indication (e.g., the time interval may be indicated using a bitmap where each bit in the bitmap may be associated with a specific duration, e.g., a slot or a frame. For example, bit “1” may indicate regular activity and bit “0” may indicate reduced activity on an associated frame. The time interval may be indicated with a start time and length of interval. The start time may be defined, for example, it may be determined by adding a fixed offset to the time the indication is received. The length of the interval may be configured or signaled in the indication PDCCH); the time interval over which an activity level is assumed may be predetermined (e.g., the WTRU may assume an interruption delay, or more generally a time till the NES state changes, after the NES state change command reception (e.g., after the last symbol or slot on which the command was received). The interruption time can be in absolute time, a number of symbols, or a number of slots.

The WTRU may determine that an uplink or downlink resource or signal is available for transmission/reception and/or measurements for the determined network availability state if it is applicable in the active availability state. The WTRU may determine that a subset of measurement resources and/or signals (e.g., SSBs, CSI-RS, TRS, PRS) are not applicable in certain availability states. The WTRU may determine that a subset of uplink or downlink resources (e.g., PRACH, PUSCH, PUCCH) are not applicable in certain availability states. The WTRU may transmit some uplink signals only in a subset of NW availability states (e.g., SRS, pSRS, PRACH, UCI).

The terms network NES state and cell NES state may be used herein interchangeably. A WTRU may know the cell NES state for one or more cells, e.g., through network configuration and indication. When used as network NES state, it means the NES states of one or more cells which could be serving cells, neighbor cells, etc. A NES state may imply an activation state only for a NES state, while another NES state may correspond to the deactivation state. The terms network availability state, cell turned off, SIBI-less operation, reduced SIB 1/SSB periodicity state, (de)-active cell DTX mode/configuration, or NES state may be used interchangeably. The WTRU may determine a SSB/SIBI transmission state (whether they are transmitted and/or periodicity) implicitly from a determined active availability state, and vice-versa. Herein, a NES cell may refer to a cell that is applying at least one NES technique, is in a NES state (e.g., activated NES state), and/or is capable or configured to apply an NES technique at some point. Therefore, a non-NES cell may be used to refer to any cell that is not designated as a NES cell per this definition (e.g., not in a NES state or cannot/doesn't apply a NES technique). In one alternative, the designation of which cell that can be NES cells may be configured (e.g., by broadcast or dedicated signaling). One active NES state may correspond to the non-active period of a cell DTX and/or cell DRX pattern that is activated, while another deactivated NES state may correspond to the active period of a cell DTX and/or cell DRX pattern that is activated.

In one or more NES state(s), the WTRU may transmit a wake up signal (e.g., PRACH, SR, PUCCH, UCI on PUCCH, a MAC CE or UE assistance information) to request a change in the NES state, additional UL or DL resources, reception of on demand SSB, reception of on demand SIBI/S1, or activation of a given cell (e.g., on that is in a NES state). Triggers for the WTRU to transmit a wake-up signal and/or request reception of an on demand SSB may include any one or more of: detection of a reference signal, making a channel measurement on the cell or an associated cell less than or greater than a threshold, arrival of new data (possibly for a given LCH/LCG), amount of buffered data exceeding a threshold (possibly for a given LCH/LCG), based on positioning being within a given range, based on triggering BSR/SR, based on triggering a L3 mobility events, based on the UE or cell DTX/DRX status, based on expiry of a timer, and/or the UE receiving request from higher layers to transmit on-demand SSB request, or the like.

Herein, a radio bearer (e.g., DRB, SRB, LCH) can be used to represent or indicate a logical association between data packets and/or units, e.g., originating from the same IP flow, QoS flow, or RAN data flow. Such association may be based on such data units being associated to the same IP flow, application flow, or having the same association packet marked either by the core network or the application.

A DRB might not imply a rigid association to a given set of radio resources (e.g., a cell group, or a carrier). Data units can thus be treated elastically in lower layers without restrictions on cell groups, carriers, or a given set of physical radio resources.

The Quality-of-Service (QoS) is implemented in 5G using QoS Flows. There are two mapping levels that exist for QoS flows in 5G: (1) at the Non-Access Stratum (NAS) level and (2) at the Access Stratum (AS) level.

At the NAS level, QoS rules (or packet filters) in the WTRU and Packet Detection Rules (PDRs) in 5GC (i.e., UPF) can be used to map UL and DL packets to QoS flows, respectively. The 5GC indicates how IP/Ethernet flows should be mapped to QoS flows. The QoS indication (e.g., QFI and RQI) is carried from 5GC to a gNB for a PDU Session via the PDU Session User Plane Protocol (called “N3 encapsulation layer”) which sits above the GTPv1-U layer. From the gNB, these QoS indications (e.g., QFI and RQI) may be carried over to the WTRU over the Service Data Adaptation Protocol (SDAP) header if it is configured.

At the AS level, the QoS flow rules in the WTRU and gNB map QoS flows (QFIs) to Data Radio Bearers (DRBs). Multiple QoS flows may be mapped into single or multiple DRB.

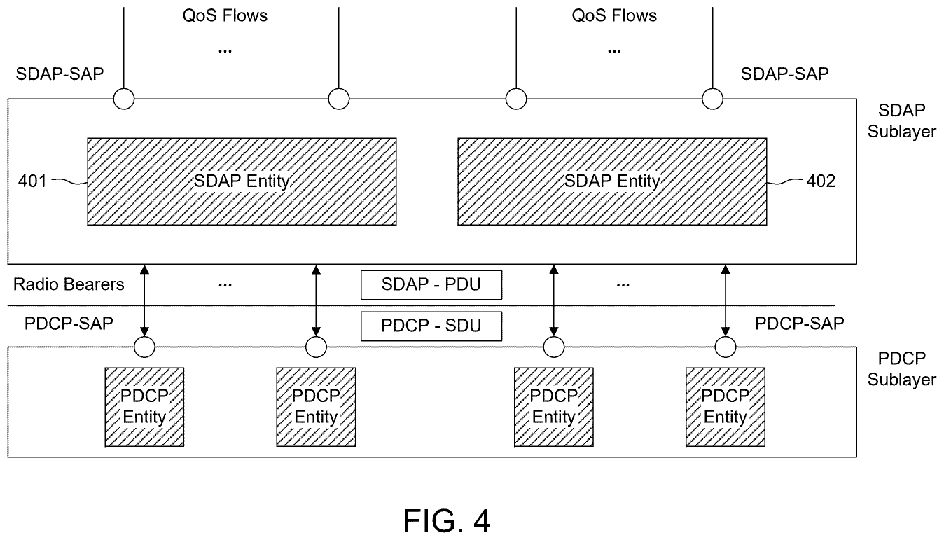

FIG. 4 illustrates an example of the SDAP layer. The SDAP layer was introduced in NR to provide better control over QoS flows between the WTRU and gNB only for the user plane (UP) traffic. The main responsibility of the SDAP layer is to map QoS flows (i.e., data packets) to DRBs for both uplink and downlink directions.

As illustrated in FIG. 4, the SDAP layer may comprise multiple SDAP entities 401, 402, each associated with a single PDU Session. If a WTRU has multiple PDU Sessions, multiple instances of the SDAP layer should be created. The RRC layer controls the initiation and release of an SDAP instance. A PDU session may carry multiple (IP/Ethernet) flows and thus should configure rules for multiple QoS flows. Each QoS flow may be mapped to a particular DRB at the SDAP layer. Each DRB is mapped to a specific PDCP layer which may translate to one or two RLC entities (e.g., multiple RLC entities if the concerned bearer is a split bearer).

In the uplink, a QoS flow may be mapped to one (e.g., only one) DRB at a time. A PDU session has at least one DRB. There is at most one default DRB in every PDU session. Therefore, when the uplink mapping rule is unavailable, the SDAP PDU is sent to the default DRB.

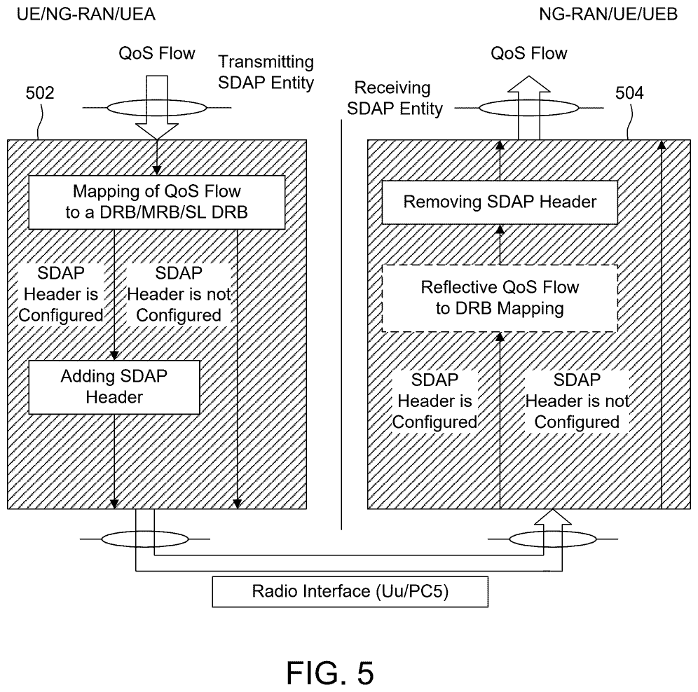

FIG. 5 illustrates an example of an SDAP diagram showing a transmitting SDAP entity 502 and a receiving SDAP entity 504. The mapping between QoS flows at the SDAP layer is configured by the RRC layer. The SDAP layer may be configured by RRC signaling for each DRB separately, for example within an SDAP configuration (“sdap-Config”) IE, which is under the “DRB-ToAddMod” parameter structure that in turn is under “radioBearerConfig”.

SDAP data PDU can be send down to the PDCP layer in three different ways: (i) without SDAP header for both UL and DL, (ii) with SDAP header for DL, and/or (iii) with SDAP header for UL. An SDAP header is configured for both UL and DL per DRB.

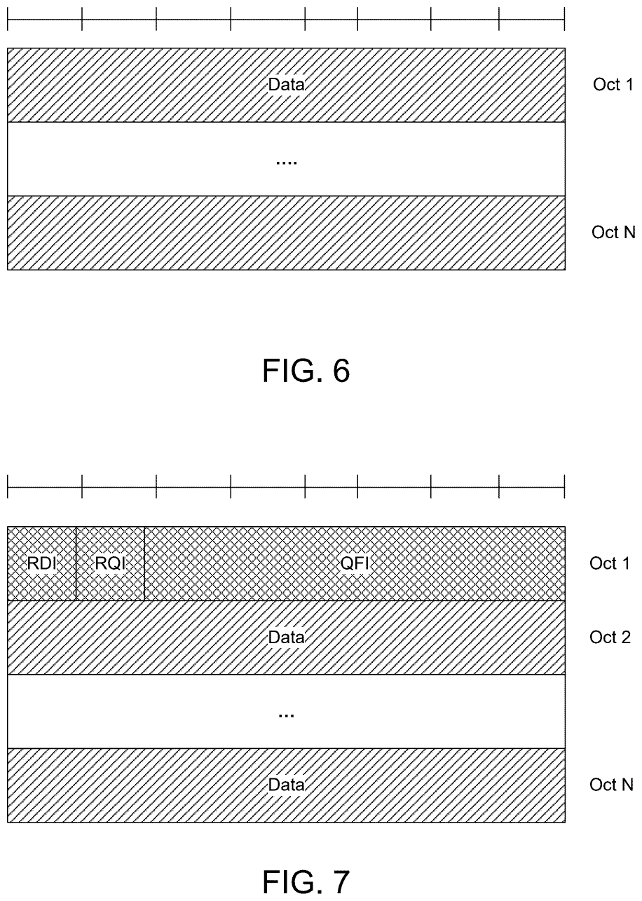

FIG. 6 illustrates an SDAP data PDU format without SDAP header. In other words, FIG. 6 shows the format when no SDAP header is configured. Note that any flows that come into the SDAP layer, which RRC does not configure to map to a specific DRB, may be placed into the default DRB. It is expected that no SDAP header is used in such scenarios.

FIG. 7 illustrates a DL SDAP data PDU format with SDAP header. In other words, FIG. 7 illustrates a scenario where the SDAP header is configured for DL. This header may be different than the UL and may include RDI (Reflective QoS flow to DRB mapping indication), RQI (Reflective QoS indicator), and QFI (QoS Flow ID) parameters.

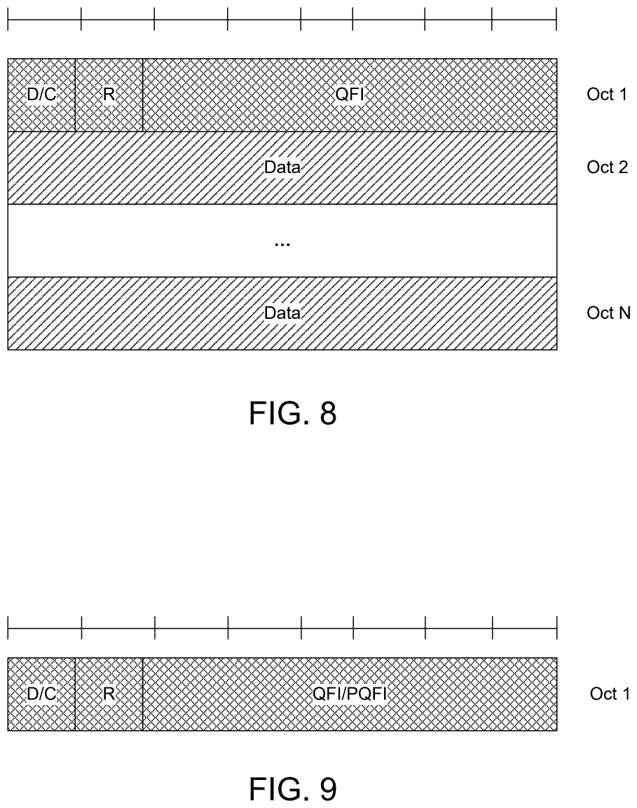

FIG. 8 illustrates an UL SDAP Data PDU format with SDAP header. In other words, FIG. 8 shows the SDAP header for an UL Data PDU format. For example, when D/C is 1 it indicates that this is DATA PDU, while 0 indicates it is Control PDU (i.e., End-Marker).

In the UL, SDAP header can become a control PDU with the size of one byte (e.g., a header without a payload) by setting D/C field to zero. A control SDAP header may be sent to obsolete a mapping for a QoS flow to a DRB (called “End-Marker Control PDU”). This may be the case when RRC configures a new mapping for a flow.

FIG. 9 illustrates an example of an end-marker control PDU. When using Reflective QoS (RQI) in the DL SDAP header, the SDAP layer may use the DRB mapping of the downlink for the uplink so that it follows whatever 5GC is configured for the downlink; if 5GC changes a QFI for a flow within a PDU Session, the WTRU may follow the same changes for the uplink direction, meaning that both the UL and DL will use the same DRB for a QoS flow. However, when the reflective QoS is not activated, then the SDAP/RRC may follow different mapping for the uplink and downlink for a flow within a PDU Session. It is noted that the reflective QoS function might not be applicable if DL SDAP PDUs do not have a header as it can only be indicated via the DL header.

Herein, when reference is made to a cell group being in a NES state or an active NES state, this may refer to or include one or more of the following: (1) the cells (e.g., all cells) in that cell group are in an active NES state (e.g., off, cell DTX/DRX etc) or using at least one NES technique; (2) there is no cell in the cell group that is not in a NES state or an active NES state; (3) the primary cell in the cell group is in a NES state (for example, “SCG is in NES state” may refer to the fact that the PSCell is in a NES state or an active NES state); (4) the primary cell in the group is in a NES state (e.g., PSCell of an SCG or the PCell of an MCG) and other SCells are in a NES state; (5) at least one cell in the cell group in a NES state, an active NES state, or using at least one NES technique; and/or (6) the base station (e.g., gNB) associated with the cell group is in a NES state (e.g., cell DTX/DRX, off, low power operation etc.).

Some example embodiments may include or may be directed to procedures for data routing in multi-connectivity with NES. In some embodiments, a WTRU may be configured with (e.g., may receive configuration information indicating) a SDAP mapping (or association) that is dependent on the NES state of the MN and the SN.

According to some embodiments, the WTRU may be configured with (e.g., may receive configuration information indicating) a mapping or association of one QFI to multiple DRBs (e.g., one MCG DRB and one SCG DRB), and a condition (e.g., a condition for selecting or determining) when the QFI is to be mapped to one of the DRBs, where the condition is the NES state of the MCG or the SCG. As one example, the mapping could be, for QFI x: if the MCG is not in NES and SCG is in NES state, then map the QFI to the MCG DRB; else if the SCG is not in NES and MCG is in NES state, then map the QFI to the SCG DRB; else (i.e., both are in NES or both are not in NES), map the QFI to the MCG DRB.

In the above example, it was assumed that the MCG DRB was prioritized in case both MCG and SCG were not in NES state. However, the WTRU can also be configured (or may determine) the other way (i.e., where the SCG is prioritized).

In one example, a QFI may be mapped to more than 2 bearers, e.g., an MCG bearer, an SCG bearer, and/or a split bearer. For example, a mapping rule in this case could be, for QFI x: if the MCG is not in NES and SCG is in NES state, then map the QFI to the MCG DRB; else if the SCG is not in NES and MCG is in NES state, then map the QFI to the SCG DRB; else if both SCG and MCG are not in NES state, then map the QFI to the MCG DRB; else (e.g., both are in NES state), map the QFI to the split DRB.

According to certain embodiments, the mapping can be more granular depending on the NES state type. For example, it may be assumed that the SCG is in a cell DTX/DRX operation, where it has an ON period of length t_on and OFF period of length t_off. The WTRU may be configured with a mapping such as: map the QFI to the SCG bearer associated with the QFI during the SCG t_on period, map the QFI to the MCG bearer associated with the QFI during the t_off period.

In some embodiments, the WTRU may be configured with a delta time (t_delta) that takes into account the amount of processing time required for a packet to be processed at the protocol layers (e.g., the time taken from the reception of the SDAP PDU at PDCP and packet is ready for transmission at MAC layer). For example, the mapping may become: map the QFI to the SCG bearer associated with the QFI between t_delta before the SCG t_on period and t_delta before the t_off period; otherwise, map it to the MCG bearer associated with the QFI. For example, the t_delta can be WTRU specific or it can be for more than one or all WTRUs (e.g., as part of the NES state configuration). For example, the t_delta can be an absolute time value or a percentage of the t_on or t_off periods.

According to some embodiments, the mapping may consider available resources/grants at the MCG and SCG and/or buffered data waiting to be transmitted at the MCG and SCG. An example scenario includes where a certain QFI is mapped to DRB1 and DRB2, where DRB1 is an MCG bearer and DRB2 is an SCG bearer, and DRB1 is set as the default/prioritized one (e.g., to be used for both SCG and MCG are not in NES). Some examples of a mapping that considers the available resources at the MCG/SCG may include: if the MCG is in NES state, map the QFI to the SCG if the WTRU has UL resources granted on the SCG leg at that time (e.g., dynamic grants, configured grants, etc.); if the MCG is in NES state, map the QFI to the SCG if the amount of buffered data on the SCG leg (e.g., at PDCP level and/or RLC level and/or MAC level) is below a certain level and/or if the amount of buffered data on the MCG leg is above a certain level.

In some embodiments, the WTRU may perform the remapping based on the buffer levels at the MCG/SCG and the data activity. For example, a scenario may be envisioned where the WTRU is originally configured to map QFI x mapped to DRB1 (SCG DRB) and DRB2 (MCG DRB), where DRB1 was set as the default. Even if the SCG starts operating in an NES state, the WTRU may be configured to perform the remapping according to any of the solutions above if the WTRU does not determine a considerable buffering/delay of the data belonging to this QFI (e.g., as compared to the pre-NES state operation), remapping may not be required. However, if the WTRU determines that there is a considerable buffering/delay of the data belonging to this QFI, it may perform the remapping to the DRB2 (e.g., during the DTX/DRX off periods of the SCG, as described in some of the solutions above). The WTRU may be configured with delay or buffer level thresholds to determine what is a “considerable” increase in delay or buffer levels, as compared to the pre-NES operation. For example, this could be absolute values or relative/percentage values. For example, the WTRU may monitor the average time/delay between the reception of the SDAP PDU at PDCP layer and the discarding of that packet due to the reception of an ACK that the packet has been successfully received (e.g., based on PDCP status reports, RLC status reports, RLC ACKs, etc.), and if it determines the delay value has increased by more than the configured absolute/relative threshold after the SCG has entered the NES state, it may activate/perform the remapping.

In some embodiments, the WTRU may request a remapping to be configured/activated based on any of the conditions described above (e.g., absolute/relative buffer levels, absolute/relative delay levels, etc.,) and may activate the remapping upon (e.g., only upon) an ACK from the network (e.g., WTRU indicates the request using a an RRC message, a MAC CE, a UCI, etc., and network confirms it using an RRC message, a MAC CE or a DCI, etc.).

According to some embodiments, the WTRU, upon changing the mapping of a certain QFI from one DRB to another, based on any of the examples above, may send an indication to the network about the remapping. In one example embodiment, the indication may be an SDAP control PDU (e.g., an END marker PDU, a new control PDU, etc.). In one example embodiment, the indication may be a PDCP control PDU. For example, this may include the Sequence Number (SN) of the last PDCP packet that was sent via the previously mapped DRB (and/or the PDCP SN of the first packet that is being sent via the newly mapped DRB). In one example embodiment, the indication may be an RRC message (e.g., a UE assistance information, or new UE originating RRC message). In one example embodiment, the indication may be a MAC CE.

It should be noted that any of the above mapping rules can be done per QFI/bearer level, or can be done at the WTRU level (i.e., applicable to all bearers/QFIs), or for a certain group of bearers/QFIs (e.g., a common mapping rule for bearers of a certain QoS profile, e.g., best effort bearers, URLLC bearers, etc.). For example, the QFI mapping may be at QFI level (e.g., QFI x mapped to DRB1 and DRB2, QFI y mapped to DRB3 and DRB4, etc.,) and one rule may be configured to prioritize the MCG or the SCG bearer for all QFIs depending on the NES state of the MCG and SCG.

Some embodiments may include or may provide a PDCP mapping to RLC bearers that is dependent on NES state.

In legacy NR, a PDCP is associated with the MCG or SCG, even if it is a split bearer. That is, even if the bearer is a split bearer, the peer PDCP entity is established only at the MN or SN (i.e., at the MN if it is an MN terminated split bearer and SN if it is an SN terminated split bearer).

According to some embodiments, a new type of bearer may be defined that has one PDCP entity at the WTRU but two PDCP peer entities at the network, one at the MN and another at the SN. Henceforth, this bearer may be referred to as a multi-homed bearer. Like a split bearer, a multi-homed bearer is also associated with two RLC bearers, one associated to the MCG and the other associated with the SCG.

When a WTRU is configured for dual connectivity (DC), it will have two security contexts, one for the MCG bearers and another for the SCG bearers. The security context in this case refers to the integrity protection and encryption keys to be used for user plane and control plane bearers (i.e., DRBs and SRBs). These keys may include: KUPene. MCG is the Key used for the encryption/decryption of UP traffic over the MCG, KUPint. MCG is the Key used for the integrity protection/verification of UP traffic over the MCG, KUPene, scG is the Key used for the encryption/decryption of UP traffic over the SCG, and KUPint. SCG is the Key used for the integrity protection/verification of UP traffic over the SCG. The aforementioned keys can be derived based on legacy security key update mechanisms.

In some embodiments, a PDCP entity associated with a multi-homed bearer may be configured to use both MCG and SCG security contexts in sending/receiving data, depending on the NES state of the MCG or SCG.

In the DL, if the PDCP is receiving the data from the RLC entity associated with the MCG, the WTRU may use the security context of the MCG to perform decryption and integrity verification (e.g., if integrity verification is configured for that bearer). Similarly, if the data is received from the RLC entity associated with the SCG, the SCG security context will be used.

In the UL, the WTRU may first determine to send a packet over the MCG or SCG leg (e.g., as described below, based on the NES states of the MCG or/and SCG), and once that decision is made, the WTRU may use the security context of the chosen leg to encrypt and/or integrity protect (if configured) the PDCP packet before it sends it to the corresponding RLC entity.

Any of the examples described above regarding the SDAP level mapping of a QFI to multiple bearers can also be applied here. Several examples are provided in the following (which may assume initially the SCG leg was the default leg chosen for the multi-homed bearer). As one example, packets arriving at PDCP while the SCG is in NES state may be security protected using the MCG security context and pushed to the RLC entity corresponding to the MCG. As another example, packets arriving before a certain time duration of the SCG going into cell DTX/DRX ON period and before the cell DTX/DRX OFF period are security protected using the MCG security context and pushed to the RLC entity corresponding to the MCG. As another example, packets arriving at PDCP while the SCG is in NES state while there is a buffer level of more than a certain threshold at the MCG (e.g., based on buffer levels at PDCP, RLC and MAC associated with the MCG) may be security protected using the SCG security context and pushed to the RLC entity associated with the SCG. As another example, if a switch to the MCG leg and MCG security context is decided upon (according to any of the solutions above), the WTRU may be configured to send at least a certain (configurable) number of packets that way before using the SCG leg and SCG security context (e.g., if the decision was made to make the switching at PDCP SN x, the WTRU may be configured to use the chosen security context and corresponding RLC leg for the next n packets, i.e., up to SN x+n). Another alternative to this could be a time duration threshold instead of the number of packets (e.g., use the newly chosen security context and RLC leg for the configured duration before switching back to the previous/default one, etc.).

Some embodiments may include or may relate to UL split bearer operation with NES. For example, some embodiments may include procedures for cell group selection for split bearers with NES. The WTRU may be configured with a split bearer where the bearer is split over at least two cell groups, where one or more cell groups may be in a NES state and/or use at least one NES technique. For example, a WTRU can be configured with a split bearer over a MCG and an SCG where the MCG and/or the SCG may be in cell DTX and/or cell DRX (where cell DTX and/or cell DRX is activated).

If, for example, a NES state is active or activated on at least one cell group configured for the split bearer and/or the WTRU has uplink data (e.g., CG-PUSCH transmission) or control information (e.g., an SR, UCI, or CSI reports) to transmit, the WTRU may select a cell group to transmit the data and/or control information. For example, the WTRU may select a cell group to transmit the data and/or control information based on, or as a function of, any one or more of the following: multi-connectivity NES configuration, time (absolute, dependent on packet, etc.), cell load (e.g., measured and/or signaled), type of data, split buffer threshold(s) and/or primary path(s) that are NES state dependent.

For example, with respect to multi-connectivity NES configuration, one of the cell groups may be configured as the default/primary group for a given bearer. If the primary group is not in NES, the WTRU may push (e.g., always push) the PDCP packet on the path associated with the primary group (e.g., push the PDCP packets to the RLC entity that is established over the cell group that is considered as primary). If a NES state is activated on more than one cell group and/or if there is no cell group that is not in an active NES state, the WTRU may select the cell group on which the next uplink availability period (e.g., on duration, or cell DRX active period) is occurring next. If at least one cell group is not in a NES state, the WTRU may select the cell group on which a NES state is not activated. The WTRU may keep the legacy selection rule (e.g., based on the buffered data volume), and select (e.g., only select) a different cell group if the group selected by the legacy rule is in a NES state.

For example, with respect to time (absolute, dependent on packet, etc.), this may be the time until the next on duration on the cell group selected by normal rules (e.g. data volume-based selection) and/or as a function of the cell DTX/DRX period. For example, if the time remaining until the next on duration on which the WTRU can transmit uplink data or control is larger than a configured or predetermined threshold, the WTRU may select another cell group for the transmission (e.g., that is not in a NES state) and that is configured for the split bearer. As another example, this may be delay bound, e.g., if the time remaining until the next on duration on which the WTRU can transmit uplink data or control is larger than the time until the delay budget (e.g., of the DRB, QoS flow, or PDU set) is met or not or if the cell DTX/DRX period is larger than the delay budget or the remaining time in the delay budget, the WTRU may select another cell group for the transmission (e.g. that is not in a NES state) and that is configured for the split bearer. The time remaining may be related to a scheduling max delay associated with the data QoS class, the application, or a core network parameter associated with the service. For example, when selecting a cell group with an earlier uplink availability period, while the other cell group has a longer ON duration/cell DRX active period, the WTRU may select the group with the earlier availability period, for example possibly conditioned on whether data volume at the WTRU is above or less than a threshold.

For example, with respect to cell load (measured, signaled), this may be as a function of cell congestion or cell load, which may be dynamically indicated to the WTRU or determined as a property of scheduling information, as a function or a property of a downlink received signal or channel or an indication by DCI, and/or as a function of a measurement of a channel condition(s) being above or below a configured threshold. The WTRU may select a cell group if detects a periodic signal above a threshold (e.g. an SSB transmission etc.).

For example, with respect to type of data, this may be as a function of the type of uplink data to be transmitted (e.g. control, SRB, MAC CE, AI/ML data, data from an LCH/data flow with priority/importance higher than a configured threshold, sensing data, positioning data etc.), and/or as a function of the LCH(s) from which data is multiplexed. As a further example, a new uplink data volume threshold may be applied, e.g., if at least one cell group of the configured ones for the split bearer is in an active NES state. If the amount of buffered data for transmission is less than a threshold, the WTRU may continue to select primary group configured for the split bearer (e.g. an MCG). If the amount of buffered data for transmission is larger than a threshold, the WTRU may select a non-primary group configured for the split bearer (e.g. an SCG), e.g., that is not in a NES state. If the amount of buffered data for transmission is larger than a threshold, the WTRU may select a non-primary group configured for the split bearer (e.g. an SCG) that is in a NES state and transmit a wake-up signal (e.g. towards the cell group in cell DTX/DRX) or assistance information (e.g. a BSR) towards a cell group not in cell DTX/DRX. The WTRU may indicate a preference for a given cell group to stay awake (e.g. for cell DRX to be deactivated), for example, as part of assistance information to avoid activation of a NES state. For example, if data volume is less than a threshold, the WTRU may select the cell group with the longer cell DRX active period and/or not change the configured cell group for data routing.

For example, with respect to split buffer threshold(s) and/or primary path(s) that are NES state dependent, a split bearer may be configured with different and/or multiple threshold (e.g., ul-DataSplitThreshold) values, each associated with different NES state of the primary or secondary path. For example, if the SCG was configured as the primary path for a split bearer, a first threshold (e.g., ul-DataSplitThreshold_non_NES) can be configured to be used when the SCG is not in NES state, and a second threshold (e.g., ul-DataSplitThreshold_NES) can be configured to be used when the SCG is in NES state. If there are multiple NES state, different threshold(s) can be associated with each state.

In some embodiments, a new threshold can be introduced that will be used to limit the maximum buffer size over a path in NES state. For example, if the SCG was the primary path for a split bearer, the PDCP entity for that bearer will push packets over the SCG leg only if the buffered data over that leg is below this new configurable threshold, and otherwise pushed the data over the MCG leg. This can be configured to be applicable in different ways while the SCG is in NES state. For example, in a case where the SCG starts operating in cell DTX/DRX (i.e., cell is ON for t_ON and then OFF for t_OFF), the maximum buffer level threshold can be considered in any of the following ways: as long as the SCG is operating in this way (i.e., it doesn't matter whether the SCG is currently in DTX/DRX ON or OFF period), during (e.g., only during) the DTX/DRX ON period (i.e., when that leg is not going to be available), different maximum thresholds used for the DTX/DRX ON periods and DTX/DRX OFF periods, and/or a time lag duration defined (e.g., maximum buffer threshold to be considered between a time lag duration before the DTX/DRX ON period and a time duration before the DTX/DRX OFF period).

According to some embodiments, the primary path may be configured to be NES dependent. For example, when the configured primary path is determined to be in NES state, the WTRU may consider the other path to be the primary path. This could be more granular than just the NES state (e.g., consider the other path to be the primary path only during the cell DTX/DRX periods of the original primary path, and/or consider the other path to be the primary path during all durations as long as the original primary path in operating in cell DTX/DRX, etc.).

As an example in view of the above, if one cell group is in an active NES state, the WTRU may dynamically reroute or move a bearer to another cell group (e.g. RLC entity) on which NES state is not active (without having to reconfigure the bearer to another node). In some embodiments, such a bearer can be configured as a split bearer with the data threshold set to infinity (or configured with a special behavior). Such configuration may be associated to at least one cell group (for which a split bearer is configured) that is in an active NES state. During an active period of the SN, the WTRU can select a SN cell group (e.g., possibly if the UL data volume is larger than the configured threshold). During a non-active period of the SN, the WTRU can select the MN cell group to transmit the data (e.g., regardless of the UL data volume). In certain embodiments, as one example, this may be conditioned on whether the time to the next on duration is larger than a threshold. If the desired uplink transmission is triggered by a BSR or arrival of data from a certain type of service, and/or LCH, and/or DRB, the WTRU may indicate such data arrival or BSR on a PUSCH transmission to the MN (e.g. a MAC CE).

Some embodiments may include or be directed to a procedure for path selection for packet duplication over multiple paths with NES. For example, a WTRU may be configured with (e.g., receive configuration information indicating) packet duplication and/or encoding over at least two cell groups, e.g., where one or more cell groups may be in a NES state or use at least one NES technique. It is noted that, as used herein, duplicates may also refer to forward error encoded packets transmitted over different paths. For example, a WTRU can be configured with a dual connectivity PDCP duplication bearer where the MCG and/or the SCG may be in cell DTX and/or cell DRX (where cell DTX and/or cell DRX is activated). Duplicated packets may be applicable for duplication bearers, split bearers, or any bearer with multi-connectivity or the like, or any bearer for which reliability is necessary.

Some embodiments may include or relate to conditions for selecting path(s) for duplication (e.g., on which to duplicate packets). For example, if a NES state is activated on at least one cell group configured for the split bearer and the WTRU has uplink data to transmit, the WTRU may select a cell group(s) over which duplicates are transmitted as a function of at least one of the NES state(s) of the associated cell groups. The WTRU may be configured with a plurality of cell groups and/or carriers over which duplication is possible, the WTRU may select the carriers and cell groups over which duplicates are transmitted by filtering carriers on which a NES state is activated (e.g., cell DRX or DTX).

In some embodiments, the WTRU may transmit duplicated packets on the same cell group without NES (e.g., one RLC entity instead of two) if one cell group of a (e.g., DC) duplicated bearer is in an active NES state, possibly on different carriers of the same cell group and/or possibly if there are no other cell groups on which simultaneous duplicates can be transmitted.

Some embodiments may include or may relate to conditions for whether to transmit a duplicate (e.g., conditions for determining whether to transmit a duplicate packet). The WTRU may deactivate or suspend PDCP duplication (e.g., temporarily), if one of the cell groups activates a NES state, if one cell group of a DC duplicated bearer is in NES state active, and/or if there are no other cell groups on which simultaneous duplicates can be transmitted.

In some embodiments, the WTRU may transmit duplicate packets or data units on more than one cell group or carrier if the time difference between the transmission occasions (e.g., on both legs—either on DC or CA) of the duplicated packet or data unit (e.g., PDU) is less than a configured threshold. For example, the WTRU may duplicate packets or data units on different paths (e.g. the same paths as initially intended regardless of NES states) even if one path is in cell DRX if the time between the duplicate transmission occasions is no larger than a threshold.

According to some embodiments, for CA based duplication, the WTRU may suspend duplication on the carrier with a NES state activated (e.g. during non-active periods) or change the carriers on which duplication is done. For example, the WTRU may be configured with four carriers on which two duplicates can be transmitted, but then select any two carriers for transmitting the duplicates as long as they are not in an active NES state or in a cell DRX non-active period. For instance, in some embodiments, such configuration may be conditioned to apply when (e.g., only when) a carrier over which duplication is configured activates a NES state.

In some embodiments, the WTRU may still submit duplicates to lower layers (e.g. RLC/MAC) even if the associated cell groups are in an active NES state. Upon receiving an ACK for the duplicated packet, e.g., that was transmitted using a different path, the WTRU may discard duplicated packets that are not yet transmitted or not yet acknowledged.

FIG. 10 illustrates an example flow diagram of a method 1000 for or relating to data routing (e.g., as introduced and discussed above), for example in multi-connectivity with NES, according to some example embodiments. The example method 1000 of FIG. 10 and accompanying disclosures herein may include, may be based on, or may be a synthesization of various embodiments or elements discussed in detail above. For convenience and simplicity of exposition, the example of FIG. 10 may be described with reference to the architecture or system described above with respect to FIGS. 1A-1D, for instance. However, the example method 1000 depicted in FIG. 10 may be carried out using different architectures as well. According to some embodiments, the method 1000 of FIG. 10 may be implemented by a UE or WTRU, such as the WTRU 102 described in the foregoing.

It is noted that the method 1000 of FIG. 10 may include further steps, procedures or details as discussed in detail elsewhere in this disclosure. As such, the method 1000 of FIG. 10 may be modified to include any of the steps, procedures, elements and/or details illustrated and/or discussed in the foregoing. Moreover, it is noted that the method and/or blocks of FIG. 10 may be modified to include, or to be replaced by, any one or more of the procedures, elements or blocks discussed elsewhere herein. As such, one of ordinary skill in the art would understand that FIG. 10 is provided as one example and modifications thereto are possible while remaining within the scope of certain example embodiments.

As illustrated in the example of FIG. 10, the method 1000 may include, at 1010, receiving configuration information. The configuration information may include or may indicate a first cell group and a second cell group (e.g., information relating to or associated with the first and second cell group). The configuration information may include or indicate one or more data flows (e.g., information relating to or associated with one or more data flows). For example, the data flows may be or may include QoS flows. At least one of the first cell group and the second cell group are capable of (e.g., able to or configured to) applying NES techniques or methods, and/or able to enter a NES state. For example, the data flows (e.g., QoS flow) may be associated with radio resources of one of the first cell group (e.g., DRB(s)) and the second cell group (e.g. a QoS flow to DRB mapping).

As discussed elsewhere herein, NES techniques or methods may include, but are not limited to, cell discontinuous reception (DRX), cell discontinuous transmission (DTX), powering off, or the like. In other words, a NES state may include cell discontinuous reception (DRX) and/or cell discontinuous transmission (DTX).

Additionally, as discussed elsewhere herein, the NES state is active or may be considered activated on the first cell group when, or on condition that, any of: a base station associated with the first cell group (or the second cell group) is in the NES state, all cells in the first cell group (or the second cell group) are in the NES state, and a primary cell in the first cell group (or the second cell group) is in the NES state.

As further illustrated in the example of FIG. 10, the method 1000 may include, at 1020, for example based at least on a NES state being activated on the first cell group, routing, rerouting or moving (e.g., or otherwise steering or controlling) a data flow associated with (e.g., that is initially associated with) the radio resources of the first cell group to the second cell group that is not in the NES state. In other words, when the first cell group is a NES state, the WTRU may select the second cell group (or any cell group) that is not in an active NES state to route or move the data flow to. In some embodiments, the first cell group may be a master cell group (MCG) and the second cell group may be a secondary cell group (SCG). However, in certain embodiments, the first cell group may be a SCG and the second cell group may be a MCG.

In some embodiments, the routing, rerouting, or moving of the data flow associated with the radio resources of the first cell group to the second cell group that is not in the NES state may be based on the network energy saving state being activated on the first cell group and/or based on a time that the first cell group will remain in the network energy saving state being above a threshold.

As further illustrated in the example of FIG. 10, the method 1000 may include, at 1030, applying a protocol chain configuration associated with the second cell group for uplink data transmission (i.e., for transmitting the data to a network node or base station associated with a cell group). In some embodiments, it may be understood that the first cell group and the second cell group are configured with the one or more protocol chain configurations to apply (to the cell group). For example, protocol chain configurations may include or may refer to security configuration(s), PDCP, RLC, or the like. In some embodiments, the applying 1030 of the protocol chain configuration may include applying encryption keys associated with the protocol chain configuration to one or more data units associated with the uplink data transmission (e.g., keying or rekeying a data unit or service data unit (SDU) associated with the uplink data transmission using a security configuration associated with the protocol chain configuration).

According to some embodiments, the method 1000 may include providing, to a receiver of the uplink data transmission (e.g., the second cell group or a node or base station associated with the second cell group), an indication to indicate the protocol chain configuration that is being or will be applied. For example, this indication may be provided in any one or more of a header, control protocol data unit (PDU), and/or a control element (CE). In some embodiments, the indication may indicate or include any one or more of: a distinction between the uplink data relative to other data transmitted normally over the second cell group, that the uplink data would normally have been routed to another cell group (e.g., the first cell group), a data volume that would have normally been routed to another cell group (e.g., the first cell group).

As illustrated in the example of FIG. 10, the method 1000 may include, at 1040, transmitting the uplink data (e.g., data units, packets, PDUs, etc. that are associated with, or part of, the data flow, e.g., on a configured grant) and/or control information (e.g., SR) on the second cell group.

It is noted that the flow diagram illustrated in FIG. 10 is provided as one example, and modifications thereto are contemplated according to certain embodiments as discussed elsewhere herein. For example, one or more of the steps illustrated in FIG. 10 may be omitted, combined, modified and/or performed in a different order, as provided in the example embodiments discussed herein.

FIG. 11 illustrates an example flow diagram of a method 1100 for or relating to cell group selection (e.g., as introduced and discussed above), for example for split bearers with NES, according to some example embodiments. The example method of FIG. 11 and accompanying disclosures herein may include, may be based on, or may be a synthesization of various embodiments or elements discussed in detail above. For convenience and simplicity of exposition, the example of FIG. 11 may be described with reference to the architecture or system described above with respect to FIGS. 1A-1D, for instance. However, the example method 1100 depicted in FIG. 11 may be carried out using different architectures as well. According to some embodiments, the method 1100 of FIG. 11 may be implemented by a UE or WTRU, such as the WTRU 102 described in the foregoing.

It is noted that the method 1100 of FIG. 11 may include further steps, procedures or details as discussed in detail elsewhere in this disclosure. As such, the method 1100 of FIG. 11 may be modified to include any of the steps, procedures, elements and/or details illustrated and/or discussed in the foregoing. Moreover, it is noted that the method and/or blocks of FIG. 11 may be modified to include, or to be replaced by, any one or more of the procedures, elements or blocks discussed elsewhere herein. As such, one of ordinary skill in the art would understand that FIG. 11 is provided as one example and modifications thereto are possible while remaining within the scope of certain example embodiments.

As illustrated in the example of FIG. 11, the method 1100 may include, at 1110, receiving configuration information. The configuration information may include or may indicate at least two cell groups (e.g., information associated with or indicating the cell groups). The configuration information may include or may indicate one or more data flows for which data can be routed on one or more the at least two cell groups. According to some embodiments, one or more of the at least two cell groups are capable of applying network energy savings.

In the example of FIG. 11, at 1120, for example based at least on a NES state being active or activated on one of the at least two cell groups, routing, rerouting, switching or moving a data flow associated with the one of the at least two cell groups (that is in or has entered active NES state) to another one of the at least two cell groups (e.g., the WTRU may select or determine another one of the cell groups to move the data flow to). For example, the another one of the at least two cell groups (that the data flow is being routed, rerouted or moved to) may not be in the NES state, may have a next uplink transmission availability occasion that is earlier than a next uplink transmission availability occasion of the one of the at least two cell groups, may be selected based on a volume of data to be transmitted being greater than or lower than a threshold, may be selected based on one or more characteristics associated with the data, and/or may be selected based on a type of the data (e.g., if data is from a given LCH/data flow/DRB or of a certain type). For example, as discussed above in some embodiments, if the amount or volume of data is greater than a threshold (e.g., a configured threshold), then the WTRU may wait for the cell group to be in an active state (or period) or may transmit a wake up request to the cell group; otherwise (e.g., if the amount or volume of data is less than a threshold), then the WTRU may decide to route the data to the other cell group. In some embodiments, the another one of the at least two cell groups (that the data flow is being routed, rerouted or moved to) may be selected in accordance with a priority order that is based on an amount of data associated with the data flow, as discussed elsewhere herein. Moreover, various embodiments discussed above provide more information regarding how a WTRU may select a cell group to transmit data (e.g., selection based on: multiconnectivity NES configuration where a cell group may be configured as the default/primary group for a given bearer, time, cell load, type of data, split buffer threshold and primary paths that are NES state dependent, and/or the like).

In some embodiments, as shown in the example of FIG. 11, the method 1100 may include, at 1130, transmitting data (e.g., uplink data) on the another one of the at least two cell groups (e.g., the cell group that is selected to route the data flow to based at least on its NES status).

It is noted that the flow diagram illustrated in FIG. 11 is provided as one example, and modifications thereto are contemplated according to certain embodiments as discussed elsewhere herein. For example, one or more of the steps illustrated in FIG. 11 may be omitted, combined, modified and/or performed in a different order, as provided in the example embodiments discussed herein.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

In some example embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Any characteristic, variant or embodiment described for a method is compatible with an apparatus device comprising means for processing the disclosed method, such as with a device comprising a processor configured to process the disclosed method, a computer program product comprising program code instructions and a non-transitory computer-readable storage medium storing program instructions.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Although various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although some example embodiments are illustrated and described herein, the invention is not intended to just be limited to the details shown. Rather, various modifications and variations may be made in the details within the scope and range of equivalents of the claims and without departing from the spirit or scope invention.

### REFERENCES

The following references may have been referred to hereinabove, each of which is incorporated herein by reference in its entirety.
TR 38.864, “Study on network energy savings for NR (Release 18)”;
RP-234065, “New WID: Network energy savings for NR”, Ericsson;
TR 38.840, Study on UE power savings;
TS 38.321, v 18.0.0;
TS 38.213, v 18.1.0.

What is claimed is:

1. A wireless transmit/receive unit (WTRU), comprising:
circuitry, including any of a processor, memory, transmitter and receiver, the circuitry configured to
receive configuration information indicating (1) a first cell group and a second cell group and (2) one or more data flows, wherein at least one of the first cell group and the second cell group are capable of applying network energy saving techniques, and wherein the data flows are associated with radio resources of one of the first cell group and the second cell group;
based at least on a network energy saving state being activated on the first cell group, route a data flow associated with the radio resources of the first cell group to the second cell group that is not in the network energy saving state;
apply a protocol chain configuration associated with the second cell group for uplink data transmission; and
transmit the uplink data or control information on the second cell group.

2. The WTRU of claim 1, wherein the first cell group comprises a master cell group (MCG) and the second cell group comprises a secondary cell group (SCG).

3. The WTRU of claim 1, wherein the network energy saving state comprises any of cell discontinuous reception (DRX) and cell discontinuous transmission (DTX).

4. The WTRU of claim 1, wherein the network energy saving state is activated on the first cell group when any of: a base station associated with the first cell group is in the network energy saving state, all cells in the first cell group are in the network energy saving state, and a primary cell in the first cell group is in the network energy saving state.

5. The WTRU of claim 1, wherein the routing of the data flow associated with the radio resources of the first cell group to the second cell group that is not in the network energy saving state is further based on a time that the first cell group will remain in the network energy saving state being above a threshold.

6. The WTRU of claim 1, wherein, to apply the protocol chain configuration, the circuitry is configured to apply encryption keys associated with the protocol chain configuration to one or more data units associated with the uplink data transmission.

7. The WTRU of claim 1, wherein the circuitry is configured to provide, to a receiver of the uplink data transmission, information indicating the protocol chain configuration being applied.

8. The WTRU of claim 7, wherein the information is provided in any of: a header, a control protocol data unit (PDU), and a control element (CE).

9. The WTRU of claim 7, wherein the information indicates any of:
a distinction between the uplink data relative to other data transmitted normally over the second cell group;
that the uplink data would normally have been routed to the first cell group; and
a data volume that would have normally been routed to the first cell group.

10. The WTRU of claim 1, wherein the one or more data flows comprise one or more quality of service (QoS) flows.

11. A method, implemented by a wireless transmit/receive unit (WTRU), the method comprising:
receiving configuration information indicating (1) a first cell group and a second cell group and (2) one or more data flows, wherein at least one of the first cell group and the second cell group are capable of applying network energy saving techniques, and wherein the data flows are associated with radio resources of one of the first cell group and the second cell group;
based at least on a network energy saving state being activated on the first cell group, routing a data flow associated with the radio resources of the first cell group to the second cell group that is not in the network energy saving state;
applying a protocol chain configuration associated with the second cell group for uplink data transmission; and
transmitting the uplink data or control information on the second cell group.

12. The method of claim 11, wherein the first cell group comprises a master cell group (MCG) and the second cell group comprises a secondary cell group (SCG).

13. The method of claim 11, wherein the network energy saving state comprises any of cell discontinuous reception (DRX) and cell discontinuous transmission (DTX).

14. The method of claim 11, wherein the network energy saving state is activated on the first cell group when any of: a base station associated with the first cell group is in the network energy saving state, all cells in the first cell group are in the network energy saving state, and a primary cell in the first cell group is in the network energy saving state.

15. The method of claim 11, wherein the routing of the data flow associated with the radio resources of the first cell group to the second cell group that is not in the network energy saving state is further based on a time that the first cell group will remain in the network energy saving state being above a threshold.

16. The method of claim 11, wherein the applying of the protocol chain configuration comprises applying encryption keys associated with the protocol chain configuration to one or more data units associated with the uplink data transmission.

17. The method of claim 11, comprising providing, to a receiver of the uplink data transmission, information indicating the protocol chain configuration being applied.

18. The method of claim 17, wherein the information is provided in any of: a header, control protocol data unit (PDU), and a control element (CE).

19. The method of claim 17, wherein the information indicates any of:
a distinction between the uplink data relative to other data transmitted normally over the second cell group;
that the uplink data would normally have been routed to the first cell group;
a data volume that would have normally been routed to the first cell group.

20. The method of claim 11, wherein the one or more data flows comprise one or more quality of service (QoS) flows.

21. A wireless transmit/receive unit (WTRU), comprising:
circuitry, including any of a processor, memory, transmitter and receiver, the circuitry configured to
receive configuration information indicating (1) at least two cell groups and (2) one or more data flows for which data can be routed on one or more the at least two cell groups, wherein one or more of the at least two cell groups are capable of applying network energy savings; and
based at least on a network energy saving state being activated on one of the at least two cell groups, route a data flow associated with the one of the at least two cell groups to another one of the at least two cell groups, wherein the another one of the at least two cell groups is not in the network energy saving state.

22. The WTRU of claim 21, wherein the another one of the at least two cell groups is selected based on any of: (1) having a next uplink transmission availability occasion that is earlier than a next uplink transmission availability occasion of the one of the at least two cell groups, (2) a volume of data to be transmitted being greater than or lower than a threshold, (3) one or more characteristics associated with the data, and (4) a type of the data.

23. The WTRU of claim 21, wherein the another one of the at least two cell groups is selected in accordance with a priority order that is based on an amount of data associated with the data flow.
